(19) United States
(12) Patent Application Publication
(10) Pub. No.: US 2023/0083587 A1
(43) Pub. Date: Mar. 16, 2023

(54) Toilet Seat Device

(71) Applicant: Chinazo Johns, Bellflower, CA (US)

(72) Inventor: Chinazo Johns, Bellflower, CA (US)

(21) Appl. No.: 17/584,514

(22) Filed: Jan. 26, 2022

Related U.S. Application Data
(60) Provisional application No. 63/244,363, filed on Sep. 15, 2021.

(51) Int. Cl. A47K 13/30

(52) U.S. Cl. CPC A47K 13/305; H04R 1/025

(57) ABSTRACT

The present invention relates generally to a toilet seat device. The device is comprised of a lid which is connected to a seat by at least one hinge. The device is further comprised of at least one speaker, at least one laser, at least one LED light and at least one heating element. All of these components are controlled or activated by at least one motion sensor, at least one processor and/or a mobile application. The LED light and laser may further illuminate a plurality of indicia onto the interior surface of a toilet that a user can aim at while urinating. In addition, the speaker may play an audible sound that corresponds with the LED light/laser.

### CROSS-REFERENCE TO RELATED APPLICATION

The present application claims priority to, and the benefit of, U.S. Provisional Application No. 63/244,363, which was filed on Sep. 15, 2021 and is incorporated herein by reference in its entirety.

### FIELD OF THE INVENTION

The present invention relates generally to the field of toilet seats. More specifically, the present invention relates to a toilet seat device. The device is comprised of a lid which is connected to a seat by at least one hinge. The device is further comprised of at least one speaker, at least one laser, at least one LED light and at least one heating element. All of these components are controlled or activated by at least one motion sensor, at least one processor and/or a mobile application. Accordingly, the present disclosure makes specific reference thereto. Nonetheless, it is to be appreciated that aspects of the present invention are also equally applicable to other like applications, devices and methods of manufacture.

### BACKGROUND

Teaching young children to use a standard toilet can be difficult and very time consuming, as children may take a lot of time to understand and grasp the concept of using a standard toilet. Further, children may be intimidated or scared of a toilet, which makes them further reluctant to learn to use a toilet. Additionally, adults using standard toilets may be in search of a way to improve the overall experience of using the toilet. Current toilet seats known in the art are simple and do not offer an elevated or fun experience for toilet use. Toilet seats currently known in the art also need to be opened and closed manually. Therefore, a user wanting to use the toilet in the seated position will need to ensure the toilet seat is in the correct position prior to use. The same can be said for a user wanting to use the toilet in a standing position, who will need to ensure the toilet seat is in the correct position prior to use. In either of these scenarios, the user would have to manually change the position of the toilet seat prior to use. This may also cause arguments between differing users within the same household, due to leaving the toilet seat in a position that is inconvenient for the other user. Furthermore, when not in use, toilet seats lids currently known in the art remain open unless manually closed. This poses a danger to users in the bathroom not currently using the toilet, as users may drop items into the opened toilet, such as but not limited to, cell phones, hair dryers, make-up, etc., if a toilet seat is not manually closed.

Therefore, there exists a long-felt need in the art for an improved toilet seat device. There also exists a long-felt need in the art for a toilet seat device that is fun and exciting for young children learning to use a standard toilet. In addition, there also exists a long-felt need in the art for a toilet seat device that improves upon the everyday experience of using a standard toilet and makes using the toilet more fun and enjoyable, by providing added entertainment and comfort to the entire experience of using the toilet. Furthermore, there also exists a long-felt need in the art for a device that will control the position of the toilet seat and lid, such that the lid is automatically closed/opened, as well as a device that will change the position of the toilet seat to accommodate the preferences of the user using the toilet. Finally, there exists a long-felt need in the art for a device that will eliminate the hassle of manually changing the position of the toilet seat and lid, and also eliminates the need to worry about the current position of the toilet seat and lid.

The subject matter disclosed and claimed herein, in one embodiment thereof, comprises a toilet seat device. The device is comprised of a lid which is connected to a seat by at least one hinge. The device is further comprised of at least one speaker, at least one laser, at least one LED light and at least one heating element. All of these components are controlled or activated by at least one motion sensor, at least one processor and/or a mobile application. The LED light and laser may further illuminate a plurality of indicia onto the interior surface of a toilet, that a user can aim at while urinating. In addition, the speaker may play an audible sound that corresponds with the LED light/laser.

In this manner, the toilet seat device of the present invention accomplishes all of the forgoing objectives and provides a toilet seat device that is fun, exciting and educational for young children who are being taught to use a standard toilet. This device is able to be used by parents or guardians of young children to greatly reduce the difficulties that come with “potty training” their children. Further, the aforementioned device will provide all users with a more enjoyable experience while using the toilet. The device will offer users a more fun and comfortable bathroom experience. In addition, the aforementioned toilet seat device will eliminate the need to manually adjust the position of the toilet seat and lid, and creates an easier and more user-friendly way for positioning the toilet seat and adjusting the lid.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a toilet seat device that will improve the overall experience of using the toilet. The device is comprised of a lid, a toilet seat, at least one speaker, at least one laser, at least one LED light and a mobile application. The lid is further attached to the toilet seat via at least one hinge, wherein the seat further has a top surface with at least one heating element, a side surface and a bottom surface. The side surface is further comprised of a speaker, and the bottom surface is preferably comprised of one or more motion sensors, one or more LED lights and one or more lasers.

The LED lights can be used to illuminate the interior bowl area of a toilet in a plurality of colors and may be activated by the motion sensor, when the toilet seat and/or lid is lifted. The lights can further be programmed by the mobile application to pulse, flash, illuminate at differing intensities and at differing times of day/night, etc. The at least one laser further projects indicia, such as a target, text, symbol, image, etc., onto the interior bowl of the toilet, such that a user can aim at the indicia while urinating. Similarly, the laser may be activated by the motion sensor when the toilet seat and/or lid is lifted. The laser can also be programmed by the mobile application to pulse, flash, illuminate at differing intensities or at differing times of day/night, etc. In addition, the lights and laser may further be activated by, and function in conjunction with, the speaker when the speaker is activated. The speaker may also be activated by the motion sensor to produce a plurality of audible sounds, phrases, songs, etc., that may or may not be related to the indicia projected by the laser.

In any embodiment, the at least one motion sensor may be configured in any manner to sense any motion including, but not limited to, an approaching user, the position of an approaching user, entry of urine or feces into the bowl of the toilet, etc. The motion sensor may also detect approaching users to allow for the lid, seat, or seat and lid to be automatically lifted. The device is also comprised of a battery that may power the motion sensors, laser, LEDs and speaker. In differing embodiments, the battery may be disposable or rechargeable via a USB port.

Additionally, the speakers can be further programed by the mobile application to release a recording of one's voice, play one's favorite song or sound effect, and/or change the language of the toilet catch phrases. The motion sensors can be further controlled by the mobile application to remotely lower or raise the toilet seat and/or lid. Finally, “Nom Nom Nom Nom Nom” is the catchphrases of NomNom when stool enters the toilet activating the motion sensors inside. A burp will be usually heard when liquid is detected going into Nom Nom.

Accordingly, the toilet seat device of the present invention is particularly advantageous as it allows for a fun and educational experience for young children learning to use a standard toilet, and it eliminates the need to manually change the position of the toilet seat or lid. Further, the device improves the overall bathroom experience of all users.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the toilet seat device of the present invention wherein the toilet seat is down and the lid is up in accordance with the disclosed architecture;

FIG. 2 illustrates a perspective view of one potential embodiment of the toilet seat device of the present invention wherein both the toilet seat and the lid are up in accordance with the disclosed architecture;

FIG. 3 illustrates an enhanced perspective view of one potential embodiment of the toilet seat device of the present invention wherein both the toilet seat and the lid are up in accordance with the disclosed architecture;

FIG. 4 illustrates an enhanced perspective view of one potential embodiment of the toilet seat device of the present invention disclosing the LEDs and indicia in accordance with the disclosed architecture; and

FIG. 5 illustrates a graphical view of a mobile application in communication with one potential embodiment of the toilet seat device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved toilet seat device. There also exists a long-felt need in the art for a toilet seat device that is fun and exciting for young children learning to use a standard toilet. In addition, there also exists a long-felt need in the art for a toilet seat device that improves upon the everyday experience of using a standard toilet and makes using the toilet more fun and enjoyable by providing added entertainment and comfort to the entire experience. Furthermore, there also exists a long-felt need in the art for a device that will control the position of the toilet seat and lid, such that the lid is automatically closed/opened, as well as a device that will change the position of the toilet seat to accommodate the preferences of a user. Finally, there exists a long-felt need in the art for a device that will eliminate the hassle of manually changing the position of the toilet seat and lid, and also eliminates the need to worry about the current position of the toilet seat and lid.

The present invention, in one exemplary embodiment, is comprised of a toilet seat device which will improve the overall bathroom experience for all users. Further, the device will improve young children's experiences of learning to use a standard toilet, and will create an entertaining and more comfortable experience for users of all ages, as well as will eliminate the need to manually change the position of the toilet seat and lid.

The device is primarily comprised of a lid, a seat, at least one speaker, at least one motion sensor, at least one laser, at least one battery and a mobile application. In different embodiments, the device may be any suitable size or shape as is known in the art, as long as it's compatible with a conventional toilet. The device may also be made of a plurality of different materials, including but not limited to, wood, porcelain, plastic, etc. In addition, any surface of the device may be comprised of a plurality of indicia, such as patterns, logos, emblems, images, symbols, designs, letters, pictures, words, characters, animals, advertisements, brands, etc.

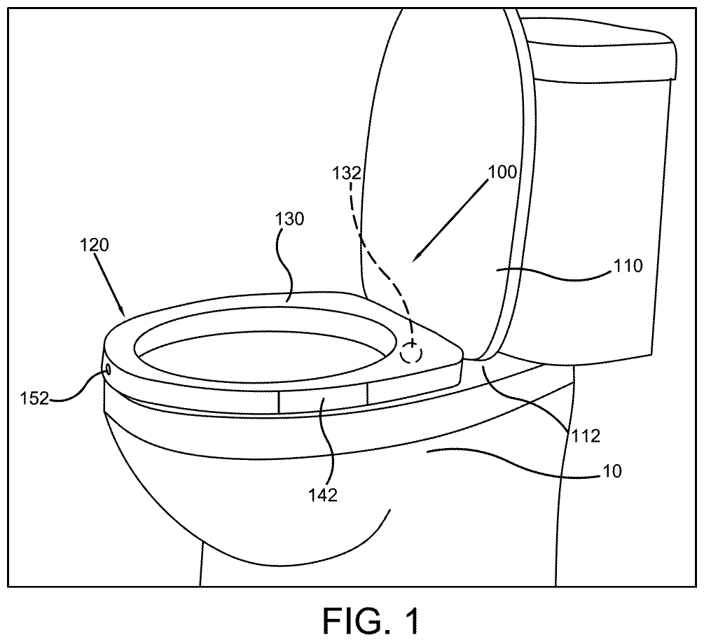

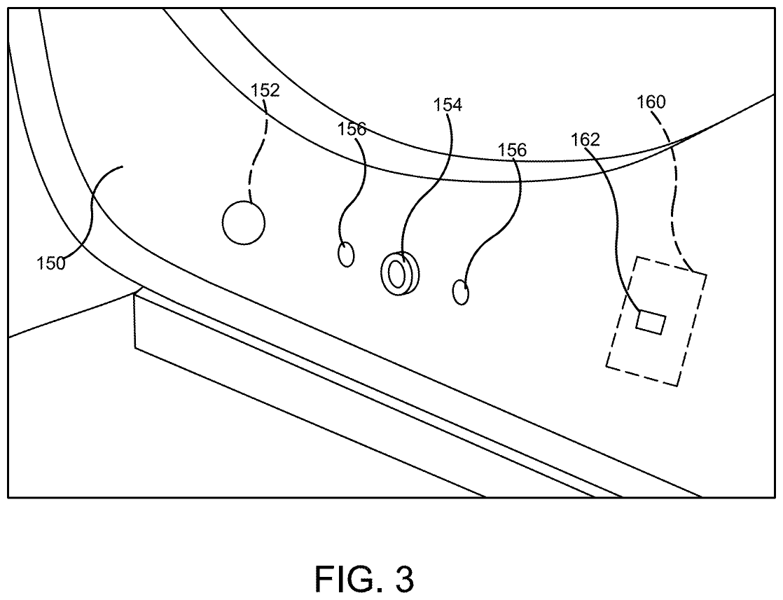

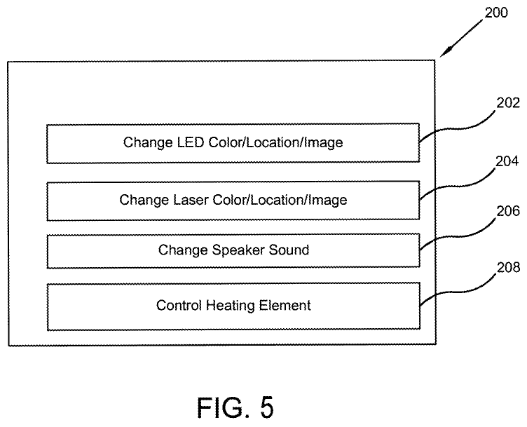

Referring initially to the drawings, FIG. 1 illustrates a perspective view of one embodiment of the toilet seat device 100 of the present invention while the toilet seat 120 is down and the lid 110 is up. The device 100 is primarily comprised of a lid 110 which is connected to a toilet seat 120, wherein the seat 120 is primarily comprised of at least one speaker 142, at least one motion sensor 152, at least one laser 154 (shown in FIG. 3), at least one battery 160 (shown in FIG. 3), and a mobile application 200 (shown in FIG. 5). In different embodiments, the lid 110 and the toilet seat 120 may be manufactured of a plurality of different materials, including but not limited to, wood, bamboo, plastic, porcelain, etc., or any other suitable material as is known in the art. In addition, the lid 110 may be attached to the toilet seat 120 by at least one hinge 112, which may be a standard hinge, a soft-closing hinge, or powered hinge that may be motorized and activated by a motion sensor 152 and powered by a battery 160, etc., or any other suitable hinge 112 as is known in the art.

The seat 120 is further comprised of a top surface 130 having at least one heating element 132 that is powered by the internal battery 160, a side surface 140, and a bottom surface 150. The top surface 130 may be hard or padded and may also be smooth or textured in differing embodiments. In a padded embodiment, the padding may be manufactured of a plurality of different materials, including but not limited to, low-density flexible foam, closed cell EVA foam, etc., or any other suitable padding material as is known in the art.

Further, the seat 120 comprises a motion sensor 152, which can be any suitable motion sensor 152 as is known in the art, and a speaker 142 which can be any suitable speaker as is known in the art. The speaker 142 can be manually activated by a user, or may also be activated by the motion sensor 152 to produce a plurality of audible sounds, phrases, songs, etc., or any other suitable sound as is known in the art. The motion sensor 152 may also be configured to sense any motion including, but not limited to, an approaching user, the position of an approaching user, entry of urine and/or feces into the toilet bowl, etc., or any other suitable motion as is known in the art. The motion sensor 152 may also detect approaching users, to allow for the lid, seat, or seat and lid to be automatically lifted.

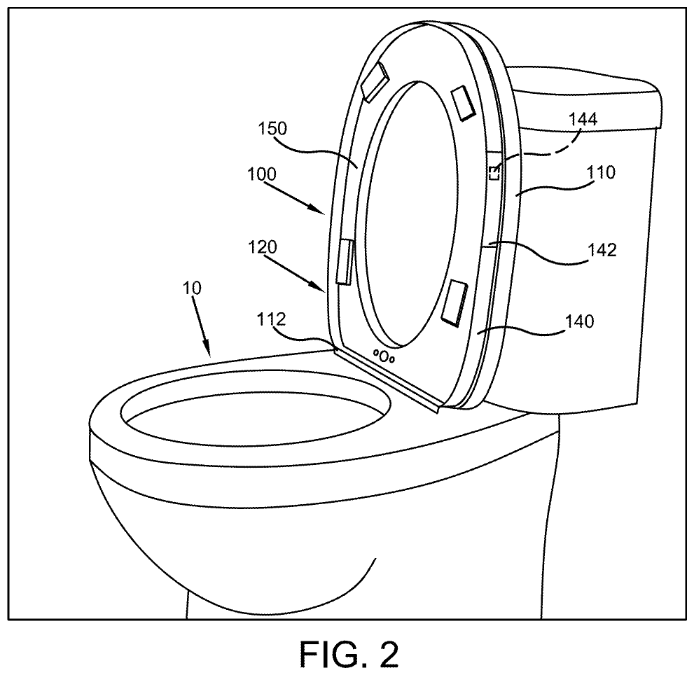

As shown in FIG. 2, the toilet seat device 100 of the present invention is disclosed with the toilet seat 120 and the lid 110 up. Further, the toilet seat 120 comprises a side surface 140 which has at least one speaker 142, which contains at least one processor 144 and is also powered by a battery 160. In addition, the lid 110 is attached to the toilet seat 120 by at least one hinge 112, which may be a standard hinge, a soft-closing hinge or a powered hinge that may be motorized and activated by a motion sensor 152 and powered by a battery 160, etc., or any other suitable hinge 112 as is known in the art.

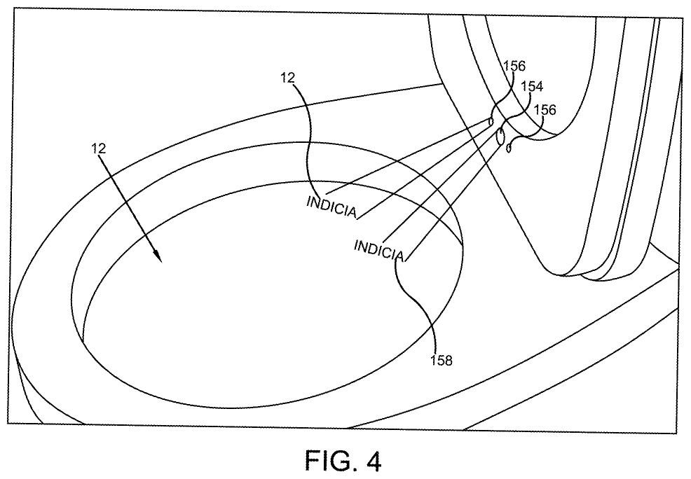

As shown in FIGS. 3-4, the toilet seat device 100 of the present invention is disclosed, wherein the bottom surface 150 comprises one or more motion sensors 152, one or more lasers 154 and/or one or more LED lights 156. In one embodiment, the LED lights 156 can be used to illuminate the interior bowl area 12 of a toilet 10 in a plurality of colors. Further, the LED lights 156 may be activated by the motion sensor 152, when the toilet seat 120 and/or lid 110 is lifted. The lights 156 can further be programmed by the mobile application 200 (shown in FIG. 5) to pulse, flash, illuminate at differing intensities, illuminate at differing times of day/night, etc. The at least one laser 154 further projects indicia 158, such as a target, text, symbol, image, etc., or any other indicia as are known in the art, onto the interior bowl of the toilet 12, such that a user can aim at the indicia 158 while urinating or defecating. The laser 154 can further be activated by the motion sensor 152 when the toilet seat 120 and/or lid 110 is lifted. The laser 154 can also be programed by the mobile application 200 to pulse, flash, illuminate at differing intensities, illuminate at differing times of day/night, etc.

The lights 156 and laser 154 may further be activated by and function in conjunction with the speaker 142, when the speaker 142 is activated. The speaker 142 may also be activated by the motion sensor 152 to produce a plurality of audible sounds, phrases, songs, etc., or any other suitable sounds as is known in the art, that may or may not be related to the indicia 158 projected by the laser 154. In different embodiments of the device 100, any of the following may be located in any configuration on any location on the device 100: the speaker 142, the motion sensor 152, the laser 154, and the LED light 156. The motion sensor 152 may also be configured by the application 200 in any manner to sense any motion including, but not limited to, an approaching user, the position of an approaching user, entry of urine or feces into the bowl of the toilet, etc. The motion sensor 152 may also detect approaching users to allow for the lid, seat, or seat and lid to be automatically lifted.

One embodiment of the device 100 further comprises a battery 160 and a USB port 162. The battery 160 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supply power to the device 100. Throughout this specification the term “battery” may be used interchangeably to refer to one or more wet or dry cells or batteries of cells in which chemical energy is converted into electricity and used as a source of DC power. References to recharging or replacing the battery 160 may refer to recharging or replacing individual cells, individual batteries of cells, or a package of multiple battery cells as is appropriate for any given battery technology that may be used. In addition, a rechargeable embodiment of the battery 160 may be recharged using a USB port 162, wherein the USB port is a USB-A, USB-B, Micro-B, Micro-USB, Mini-USB or USB-C port.

In the preferred embodiment of the device 100, as shown in FIG. 5, the device 100 is further comprised of a mobile application 200 which allows the device 100 to be in electrical communication with the processor 144. The mobile application 200 is further comprised of a plurality of functions. One such function allows the user to change the LED lights 202. As such, a user can configure the intensity (i.e., brightness), configure the brightness, configure an illumination pattern (i.e., blinking, flashing, etc.), configure the LED lights to illuminate at differing times of day or night, configure the LED lights to illuminate when the motion sensor is activated, configure the LED lights to illuminate when the speaker is activated, etc. The mobile application 200 also allows a user to configure a plurality of features of the laser, such as but not limited to: change the color/intensity of the laser, change the indicia that is projected by the laser (and allowing the user to upload their own custom indicia), changing the laser color/location/image 204, configuring the laser such that the laser only illuminates when the toilet seat is in an upward position (via detection of the motion sensor), etc. Further, the mobile application 200 may allow a user to configure the speaker 206. Using a mobile application 200, a user can adjust the volume of the speaker, configure the sound from the speaker to only play at a certain time of the day/night, upload custom sounds to be played by the speaker, etc. The mobile application 200 may also allow a user to control an embodiment of the heating element 208 that has a plurality of heating levels.

Additionally, the speakers 142 can be further programed by the mobile application 200 to release a recording of one's voice, play one's favorite song or sound effect, and/or change the language of the toilet catch phrases. The motion sensors 152 can be further controlled by the mobile application 200 to remotely lower or raise the toilet seat and/or lid. Finally, “Nom Nom Nom Nom Nom” is the catchphrases of NomNom when stool enters the toilet, thereby activating the motion sensors 152 inside. A burp will be usually heard when liquid is detected going into Nom Nom.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “toilet seat device” and “device” are interchangeable and refer to the toilet seat device 100 of the present invention.

Notwithstanding the forgoing, the toilet seat device 100 of the present invention and its various components can be of any suitable size and configuration as is known in the art without affecting the overall concept of the invention, provided that they accomplish the above-stated objectives. One of ordinary skill in the art will appreciate that the size, configuration and material of the toilet seat device 100 as shown in FIGS. 1-5 is for illustrative purposes only, and that many other sizes and shapes of the toilet seat device 100 are well within the scope of the present disclosure. Although the dimensions of the toilet seat device 100 are important design parameters for user convenience, the toilet seat device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A toilet seat device comprising:
a lid;
a seat:
at least one heating element;
at least one speaker;
at least one motion sensor;
at least one laser;
at least one LED light;
a battery; and
a mobile application.

2. The toilet seat device of claim 1, wherein the at least one laser is activated by the at least one motion sensor and projects an indicia onto an interior bowl of a toilet.

3. The toilet seat device of claim 1, wherein the at least one speaker is activated by the at least one motion sensor and produces an audible sound, a phrase or a song.

4. The toilet seat device of claim 1, wherein the at least one LED light is activated by the at least one motion sensor and illuminates an interior bowl of a toilet.

5. A toilet seat device comprising:
a lid;
a seat:
a battery;
at least on heating element located on a top surface of the seat and that is powered by the battery;
at least one speaker located on a side surface of the seat and that is powered by the battery;
a processor;
at least one motion sensor;
at least one laser located on a bottom surface of the seat and that is powered by the battery;
at least one LED light and at least one laser located on a bottom surface of the seat, wherein each of the at least one LED light and at least one laser is powered by the battery; and
a mobile application that allows a user to control the at least one motion sensor, the at least one laser, the at least one LED light and the at least one speaker.

6. The toilet seat device of claim 5, wherein the at least one laser is activated by the at least one motion sensor and projects an indicia onto an interior bowl of a toilet.

7. The toilet seat device of claim 5, wherein the at least one speaker is activated by the at least one motion sensor and produces an audible sound, a phrase or a song.

8. The toilet seat device of claim 5, wherein the at least one LED light is activated by the at least one motion sensor and illuminates an interior bowl of a toilet.

9. A toilet seat device comprising:
a lid;
a seat attached to the lid via at least one hinge:
a battery;
a USB port;
at least one heating element located on a top surface of the seat and that is powered by the battery;
at least one speaker located on a side surface of the seat and that is powered by the battery and produces an audible sound, a phrase or a song;
a processor;
at least one laser located on a bottom surface of the seat and that is powered by the battery and that projects an indicia onto an interior bowl of a toilet;
at least one LED light and at least one laser located on a bottom surface of the seat and that are both powered by the battery and illuminate the interior bowl of the toilet;
at least one motion sensor that activates the at least one speaker, the at least one laser, and the at least one LED light; and
a mobile application that allows a user to control the at least one motion sensor, the at least one laser, the at least one led light and the at least one speaker.

10. The toilet seat device of claim 9, wherein the indicia is a target, a text, a symbol or an image.

11. The toilet seat device of claim 10, wherein the user can aim at the indica while urinating or defecating into the interior bowl of the toilet.

12. The toilet seat device of claim 9, wherein the at least one hinge is a standard hinge, a soft-closing hinge or a powered hinge.

13. The toilet seat device of claim 12, wherein the powered hinge is activated by the at least one motion sensor and is powered by the at least one battery.

14. The toilet seat device of claim 9, wherein a top surface of the seat is padded.

15. The toilet seat device of claim 9, wherein the at least one motion sensor is activated when the seat is lifted, when the user approaches the toilet seat device, or when a urine or a feces enters the interior bowl of the toilet.

16. The toilet seat device of claim 9, wherein the mobile application is in wireless communication with the processor.

17. The toilet seat device of claim 16, wherein the mobile application allows the user to perform at least one action from a group consisting of: configuring an intensity of the at least one LED light, configuring a brightness of the at least one LED light, configuring an illumination pattern of the at least one LED light, configuring the at least one LED light to illuminate at a time of day or night, configuring the at least one LED to illuminate when the at least one motion sensor is activated, and configuring the at least one LED to illuminate when the at least one speaker is activated.

18. The toilet seat device of claim 16, wherein the mobile application allows a user to perform at least one action from a group consisting of: change a color or an intensity of the at least one laser, change the indicia projected by the at least one laser, change a color of the at least one laser, change a location of the at least one laser, and configuring the at least one laser to only illuminate when the seat is in an upward position.

19. The toilet seat device of claim 16, wherein the mobile application allows a user to adjust the volume of the at least one speaker, configure a sound from the at least one speaker to only play at a certain time of a day, and upload a custom sound to be played by the at least one speaker.

20. The toilet seat device of claim 16, wherein the mobile application allows a user to control a plurality of heating levels of the at least one heating element.
